(19) United States
(12) Patent Application Publication
(10) Pub. No.: US 2002/0006489 A1
(43) Pub. Date: Jan. 17, 2002

(54) Electron emitter, manufacturing method thereof and electron beam device

(76) Inventors: Yoshitaka Goth, Hitachi (JP); Kishio Hidaka, Hitachi (JP); Shoichi Hirota, Hitachi (JP); Ikuo Hiyama, Hitachi (JP); Makoto Okai, Kokubunji (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/796,689

(22) Filed: Mar. 2, 2001

(30) Foreign Application Priority Data
Jul. 7, 2000 (JP) 2000-211969

(51) Int. Cl. B32B 1/08

(52) U.S. Cl. 428/36.9

(57) ABSTRACT

High density of an electron emission at a low applied voltage is achieved for electron emitters and various products utilizing the emitters by hydrogenating lattice carbons of graphite crystallite of carbon nanotube or carbon film and thus forming >CH— bonding group.

### DETAILED DESCRIPTION OF THE INVENTION

The present invention relates to an electron emitter of carbon materials such as carbon nanotube, graphite and carbon film arrayed on an electron emission surface.

### BACKGROUND ART

Carbon nanotube is used as a field emission type electron emitter an electron emitter for Field Emission Display (FED) as disclosed in JP-A-09-274844, JP-A-10-208677 and JP-A-11-306959 and as an electron emitter for fluorescent character display tube as shown in JP-A-11-162333 and Japanese Journal of Applied Physics, 37, L346 (1998).

An electron emitter using carbon nanotube with a tubularly arrayed structure of carbon atoms has a diameter of several tens of nanometer level, and carbon nanotube of electroconductive type enables to take out a high emission current density at a lower extraction voltage due to a far smaller radius of tip curvature in comparison with a conventional electron emission sources such as an electron emitter using circular cone protrusions, when used as a field emission type electron emitter to take out electrons by applying an electric field. In addition, carbon can provides a longer life emitter because it does not melt due to its high melting point, differing from metals.

However, as carbon materials such as graphite as a typical one have work function values around 4.5 which are similar levels as of tungsten and the like, they have not necessarily realized sufficient lowering of an extraction voltage to the requirement to lower the voltage in a driving circuit system, when used as an electron emitter array. Furthermore, carbon nanotube has a feature that it essentially has a semi-metallic nature and its electric conductivity largely depends on completeness of a graphite crystal structure, although a so-called multilayer carbon nanotube in which many layers of graphite tubes have a nesting structure each other is electroconductive. Therefore, when an electron emitter is operated, in particular, under a medium degree of vacuum, that is, in a residual gas atmosphere of not less than 10⁻⁵ Pa, there is a problem that residual gas ions ionized by emitted electrons bombard an emitter, destroy a crystal array of graphite composing the emitter, and thus result in a reduced electric conductivity and deteriorated emission characteristics.

On the other hand, another method already developed is to use two-dimensionally arrayed conical protrusions, that is, minute protrusions of circular cone or pyramidal shapes, as a field emission type electron emitter. As a method for forming protrusions, there are etching method of silicon and the like, transfer method of CVD diamond and the like or so-called Spint method in which conical protrusions are formed by a vapor deposition of molybdenum or the like through micro pores, as disclosed in U.S. Pat. No. 3,789,471. These electron emitters except for CVD diamond, however, are inferior in heat resistance in comparison with carbon-based electron emitters, and thus are liable to incur an erosion by an electric discharge and do not have a sufficiently long term reliability. A CVD diamond has also a disadvantage of limited application range for manufacturing process due to its strict conditions for film formation such as substrate temperature. Furthermore, these conical electron emitters, in general, have a disadvantage that they cannot provide a sufficiently large emission current for an applied voltage due to their larger radius of curvature compared with that of carbon nanotube.

An object of the present invention is to provide a carbon-based emitter and electron beam device using it which can stably provide high density of emission current at lower voltage even under a relatively medium degree of vacuum atmosphere.

### MEANS FOR SOLVING THE PROBLEMS

Taking into consideration of the above problems, an embodiment of the present invention is an electron emitter having a >CH— bonding group consisting of a carbon atom linked to three neighboring carbon atoms and one hydrogen atom linked to said carbon atom. That is, the structure has hydrogen atoms of not only >CH₂ but also >CH— bondings arranged in defects or edge parts of graphite crystallites composing electron emitting surface or a layer just under the surface of an electron emitter. This structure enables to take out a far higher emission current than the structure without such hydrogen atom under the same electric field potential, or dramatically reduce an electric field potential required for obtaining a prescribed level of current.

Another embodiment of the present invention is an electron emitter in which a film having carbon atoms is formed on an electroconductive core protrusions, wherein said carbon atoms are those of >CH— bonding group consisting of a carbon atom linking to three neighboring carbon atoms and one hydrogen atom. This emitter has a pillar part of a composite structure of metal and graphite layer, which electrically connects a tip part of the electron emitter and substrate electrode, and thus enables to solve the problem of an emission decrease phenomenon caused by an ion bombardment under a low degree vacuum region due to a semi-metallic nature of the conventional graphite.

According to the embodiments of the present invention, there can be provided an electron emitter which has a far higher brightness in comparison with the conventional emitters and can stably work even under a medium degree vacuum region. Use of this emitter as an electron source enables a compact electron beam device with low energy consumption and high performance.

### BRIEF DESCRIPTION OF THE DRAWINGS

FIG. 1 is a drawing comparing an electron emitter made of monolayer carbon nanotube according to the present invention and that made of a conventional monolayer carbon nanotube.

FIG. 2 is a graph showing a relation between an emission current and a fraction of >CH— group of a hydrogenated multilayer carbon nanotube according to the present invention.

FIG. 3 is a longitudinal cross sectional drawing showing a crystal structure of capped carbon nanotube treated with hydrogen according to the present invention.

FIG. 4 is measurement results of Fourier Transform Infra-Red spectra of a hydrogenated multilayer carbon nanotube according to the present invention.

FIG. 5 is a graph showing a dependency of a field emission current on an extraction voltage for a hydrogenated multilayer carbon nanotube according to the present invention.

FIG. 6 is a graph showing a dependency of a field emission current on an emission temperature for a hydrogenated multilayer carbon nanotube according to the present invention.

FIG. 7 is a cross sectional structural drawing including a gate substrate, cathode, resistance layer and gate electrode of an electron emitter formed on a surface of circular cone core protrusions according to the present invention.

FIG. 8 is a cross sectional structural drawing of a carbon-based electron emitter formed on electroconductive needle-like core protrusions according to the present invention.

FIG. 9 is a cross sectional structural drawing of an electron emitter which is a carbon-based electron emitter with a coated metal layer on its external surface according to the present invention.

FIG. 10 is an example schematically showing a cross sectional structure of an image display device with two-dimensionally arrayed electron emitters according to the present invention.

### Numbers in these figures have the following meanings:

1: A carbon atom with three neighboring carbon atoms,

2: A carbon atom with two neighboring carbon atoms,

3: Hydrogen atoms, members of a >CH₂ bonding group linking to a carbon atom linked to the two neighboring carbon atoms among carbon atoms on an edge,

4: Hydrogen atoms, members of a >CH— bonding group, linking to a carbon atom linked to the three neighboring carbon atoms among carbon atoms on an edge,

5: A monolayer carbon nanotube composing a core of a capped multilayer carbon nanotube,

6: An axial part of a multilayer carbon nanotube,

7: A cap part of a multilayer carbon nanotube,

8: A hydrogenated layer in a hydrogenated multilayer carbon nanotube,

9: A deeper part without hydrogenation in a hydrogenated multilayer carbon nanotube,

10: Circular cone core protrusion,

11: Electron emitter layer,

12: Substrate,

13: Cathode,

14: Resistance layer,

15: Insulation layer,

16: Gate electrode,

17: Opening,

18: Focusing electrode,

19: Light transmission glass window,

20: Acceleration electrode,

21: Phosphor layer,

22: Side wall of a vacuum chamber,

23: Current introduction terminal for acceleration electrode,

24: Current introduction terminal for focusing electrode,

25: Current introduction terminal for gate electrode,

26: Current introduction terminal for cathode,

27: Electron beam,

28: Visible light,

29: Residual gas,

30: Carbon-based electron emitter having needle-like core protrusions,

31: Aluminum film,

32: Needle-like core protrusion,

33: Coated metal layer, and

34: Carbon nanotube.

### DESCRIPTION OF THE PREFERRED EMBODIMENTS OF THE INVENTION

Embodiments of the present invention will be explained hereinbelow using drawings.

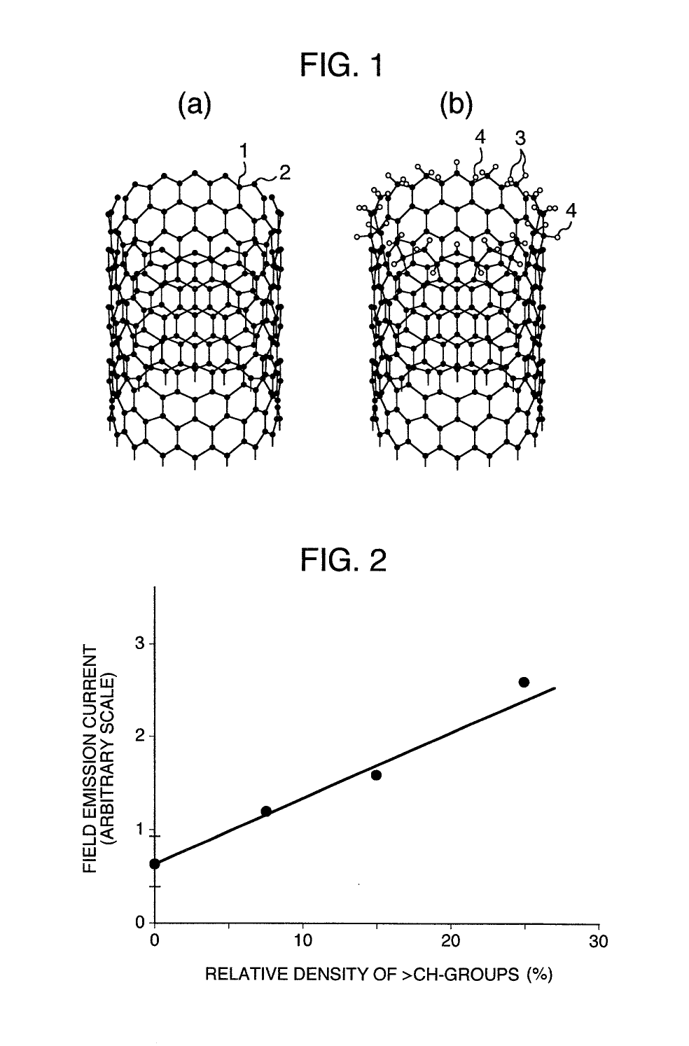

First of all, a graphite crystal structure of an electron emitter of the present invention is explained. FIG. 1 shows, as an example of an electron emitter, bird's eye views comparing a crystal structure in the vicinity of the tip of a conventional monolayer carbon nanotube without hydrogenation in FIG. 1(a), and a crystal structure of a monolayer carbon nanotube with hydrogenation according to the present invention at an edge part of the tip of the present invention in (b). The carbon atom 1 in a graphite lattice at an end surface, that is, an edge part, of a monolayer carbon nanotube in FIG. 1 shows a carbon atom linked to three neighboring carbon atoms among two bonding types of carbon atoms located on the edge. On the other hand, the carbon atom 2 shows a carbon atom on the edge linked to two neighboring carbon atoms.

The hydrogenated carbon nanotube of the present invention shown in FIG. 1(b) has a structure in which at least a surface layer just under an electron emission surface, that is an electron emitter layer, is composed of graphite crystallites with superior heat resistance and conductivity, whose defects, edge parts or five-membered ring parts are hydrogenated. The hydrogen atoms 4 show a hydrogen atom forming a >CH— bonding group linked to the carbon atom 1 shown in FIG. 1(a). And the hydrogen atoms 3 show a pair of hydrogen atoms forming a >CH₂ bonding group linking to the carbon atom 2 linked to two neighboring carbon atoms among the carbon atoms located on an edge of the carbon nanotube.

A high density of electron emission current can be provided by particularly arranging hydrogen atoms that form a >CH— bonding group at least on an electron emission surface as in an electron emitter of the present invention. Here, although only H is shown as hydrogen atom in the drawing, formation of >CD— bonding group using D, that is deuterium, instead of H also provides similar effects.

Secondly, a hydrogenation treatment to form a >CH— bonding group on an electron emission surface and a surface layer just under it of a carbon electron emitter is explained. Here, a method for producing a hydrogenated multilayer carbon nanotube according to this example will be explained. Firstly, powder of multilayer carbon nanotube was dissolved in a mixed solvent of cyclohexanone/toluene together with a polyurethane resin, followed by an ultrasonic treatment to obtain a well dispersed paste-like mixture. The paste-like mixture was then printed by silkscreen printing on a nickel electrode with a pattern formed on a glass substrate. After that, the substrate was air dried, and after optionally forming gate electrodes, introduced into a preliminary vacuuming room for degasing under a vacuum pressure of not higher than 1×10⁻² Pa at 450° C. for about three hours. Subsequently, the substrate, after the vacuum degassing, was introduced into a plasma irradiation apparatus equipped with a plasma source of microwave-excited hydrogen, where hydrogen plasma was generated in a state in which hydrogen was introduced under a vacuum of 10⁻¹ Pa. Then hydrogen ions were irradiated to the carbon nanotube electrode on the glass substrate for 20 minutes at a voltage of −150 V applied to the electrode on the glass substrate. The temperature of the substrate was maintained at 440° C. during the irradiation by heating a SUS table for mounting a substrate by electrically heating a resistance type heater locating at the back surface of the table. Thus, a hydrogenated layer with a >CH— bonding group was formed in an external circumferential surface of a multilayer carbon nanotube.

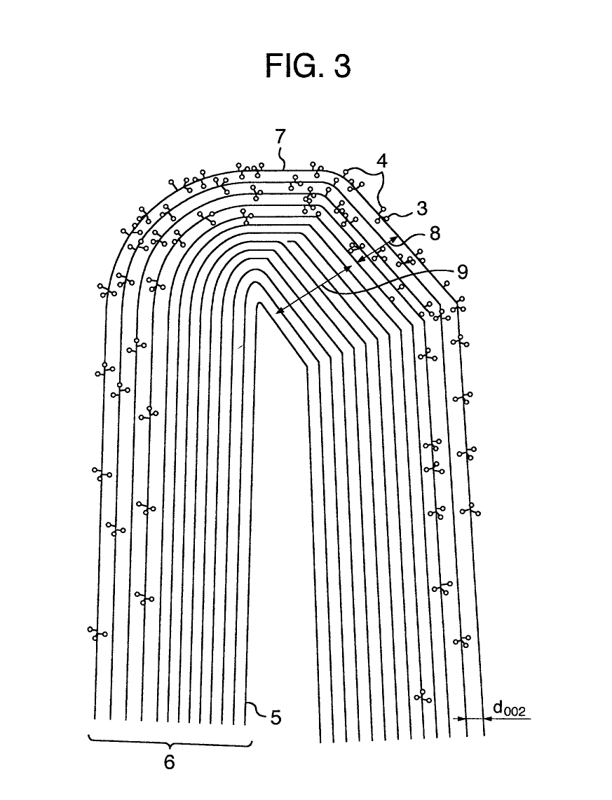

FIG. 3 shows a graphite crystal layer structure of the multilayer carbon nanotube thus obtained. FIG. 3 is a schematic drawing thereof shown by solid lines based on the results of a transmission electron microscopic observation. In the drawing, the hydrogen atoms linked to an edge part etc. of a graphite lattice are shown based on the results of a FT-IR (Fourier Transform Infra-Red Spectroscopy) analysis. The multilayer carbon nanotube is a capped type multilayer carbon nanotube in which the multilayer carbon nanotube 6 has been formed around the monolayer carbon nanotube 5 by an arc discharge between graphite electrodes in helium gas of 0.5 atmosphere. The multilayer dome-like cap 7 is similarly formed at the tip of 6. The hydrogenated layer 8 has been formed in an external circumferential surface of the carbon nanotube by the above described plasma treatment.

The results of FT-IR analysis revealed that the hydrogen atom 4 belonging to the >CH— bonding group and the hydrogen atom 3 belonging to the >CH₂ bonding group were bonded chemically to the graphite lattice. It was also found that the >CH— bonding group was linked chemically to defects or an edge surface in the graphite crystallites, or to the five-membered ring lattice carbons in the dome-like cap part.

The results of electron microscopic observation also clarified that the inter-layer spacing of graphite of the hydrogenated layers 8 was expanded to 0.37-0.43 nm which was wider than the inter-layer spacing of graphite of the inner layer 9, d₀₀₂=0.34 nm. The expansion of the inter-layer spacing of the external layer 7 is caused by the presence of C—H bondings, in particular, >CH— bonding groups. Here, the inter-layer spacing of graphite, d₀₀₂, means a distance between graphite layer lattice planes. A multilayer carbon nanotube having a structure similar to the external layer 7 in FIG. 3 can be manufactured by hydrogen ion irradiation instead of hydrogen plasma. Further, it can also be manufactured by an arc discharge evaporation deposition in a hydrogen atmosphere, or by irradiation of hydrocarbon-based materials with electrons or rare gas ions.

FIG. 2 shows a relation between the field emission current at the extraction voltage of 900 V of the hydrogenated multilayer carbon nanotube electron emitter prepared according to this example and the fraction of the >CH— bonding group in various CH bonds determined from absorption intensities by stretching vibration of CH bonds using Fourier Transform Infra-Red spectroscopy, so-called FT-IR method. The emission current by the field emission increases monotonically with the fraction of >CH— bonding group. When the fraction of >CH— bonding group is not less than 10%, the emission current increases by more than 100% as compared with the case without hydrogenation. Furthermore, when the fraction of >CH— bonding group is not less than 20%, the field emission current increases by more than 200% as compared with the case without hydrogenation.

Thus, according to the present invention, a dramatic enhancement of the field emission current can be attained by arranging >CH— bonding groups on the electron emission surface. The fraction of >CH— bonding group in various C—H bonds is preferably not less than 10%, more preferably not less than 20%.

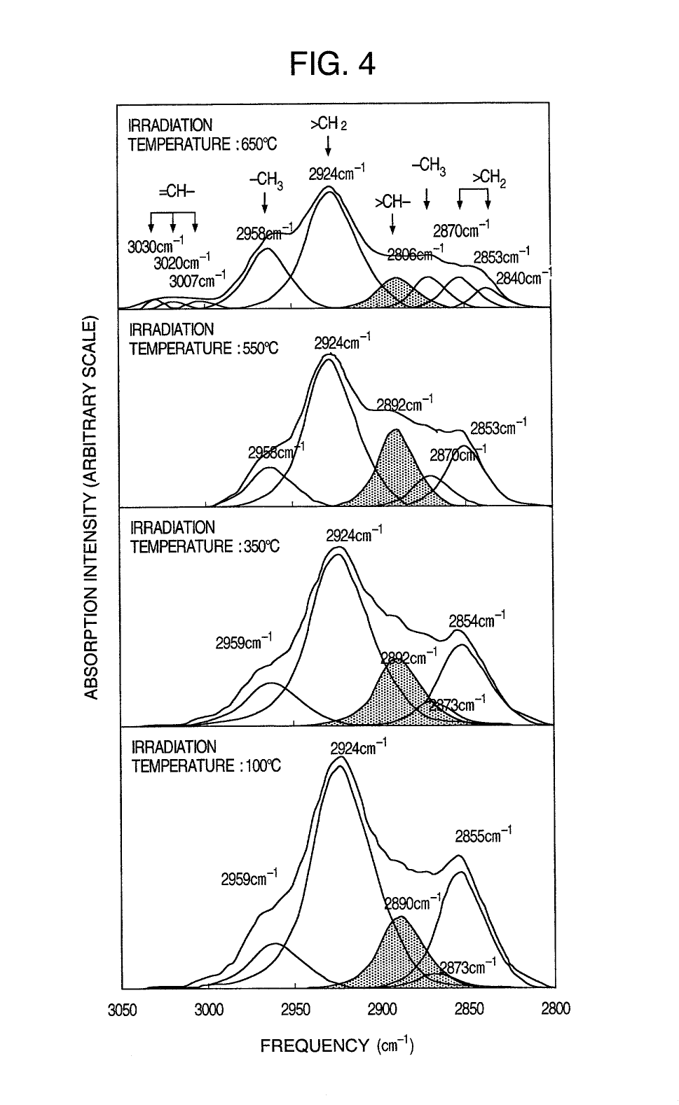

FIG. 4 shows the measurement results of infra-red absorption spectra (hereinafter the spectra) of C—H stretching vibration originated by the presence of various C—Hₓ bonding groups of multilayer carbon nanotube irradiated with hydrogen ions at various irradiation temperatures. Hydrogen ions H₃⁺of 1 keV was irradiated at the exposure rate of 1×10¹⁷ to 1×10¹⁸ H/cm² to a multilayer carbon nanotube with average diameter of 40 nm. The irradiated carbon nanotubes were mixed with KBr powder and compressed to a pellet form, and the spectra in C—H stretching vibrational infra-red absorption spectrum region were measured using a transmission type FT-IR (MODEL FTS-40A made by Bio-Rad). The resolution setting was 0.4 cm⁻¹. Each peak of the spectra was optimally and sequentially separated from each other approximately by a computer, and each peak component locating at the following wave number was separated: 3007±2 cm^{-1,} 3019±2 cm⁻¹ and 3031±2 cm⁻¹ assigned to ═CH— bonding, 2957±4 cm⁻¹ assigned to nonsymmetric stretching vibration of —CH₃ bonding, 2925±3 cm⁻¹ assigned to nonsymmetric stretching vibration of >CH₂ bonding, 2873±3 cm⁻¹ assigned to symmetric stretching vibration of —CH₃ bonding, 2855±3 cm⁻¹ and 2840±3 cm⁻¹ assigned to symmetric stretching vibration of >CH₂ bonding and 2892±4 cm⁻¹ assigned to stretching vibration of >CH— bonding. The distribution function used for the peak separation is a mixed type of Gaussian and Lorentz distributions. The half peak widths were set at 21-32 cm⁻¹ for nonsymmetrical stretching vibration of —CH₃ bonding, 23-31 cm⁻¹ for nonsymmetrical stretching vibration of >CH₂ bonding, 15-26 cm⁻¹ for symmetric stretching vibration of —CH₃ bonding, 15-23 cm¹ for symmetric stretching vibration of >CH₂ bonding and 30 cm⁻¹ for stretching vibration of >CH— bonding. In the peak separation, the area ratio of symmetric stretching vibration to nonsymmetrical stretching vibration of —CH₃ bonding was set to be in the range of 3.6-3.9, and similarly the area ratio of symmetric stretching vibration to nonsymmetrical stretching vibration of >CH₂ bonding is in the range of 2.1-2.8. The relative detection sensitivity ratio for the infra-red absorption intensity of peaks assigned to each of the groups of ═CH— bonding, —CH₃ bonding, >CH₂ bonding and >CH— bonding is known to be 0.12:2.2:1.1:1.0 from the measurement results of standard samples such as cholesterol and menthol as shown in Journal of Nuclear Materials, 266-269 (1999) 1051. Therefore, the relative densities of >CH— bonding group in the above four types of bondings can be estimated from the integrated areas of the peaks assigned to the groups. The peak component observed at around 2890 cm⁻¹, shown with meshing in FIG. 4, is assigned to >CH— bonding group. The results of peak separation showed that the ratio of >CH— bonding group to total CHₓ, bonding groups increased with the increase in the irradiation temperature when the irradiated temperature varies from the room temperature to about 450° C. but decreased inversely at about 450° C. or higher. It is meaningless, in this connection, to compare absolute peak intensities with those of other spectra in the series of FT-IR spectra in FIG. 3, in consideration with the measurement conditions, and it is important to compare the intensities among peak components within a same spectrum.

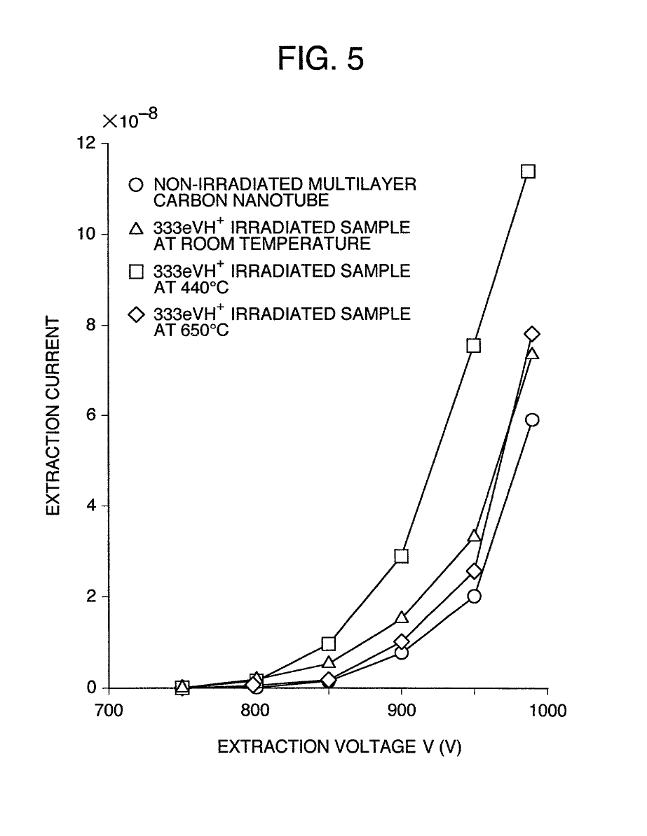

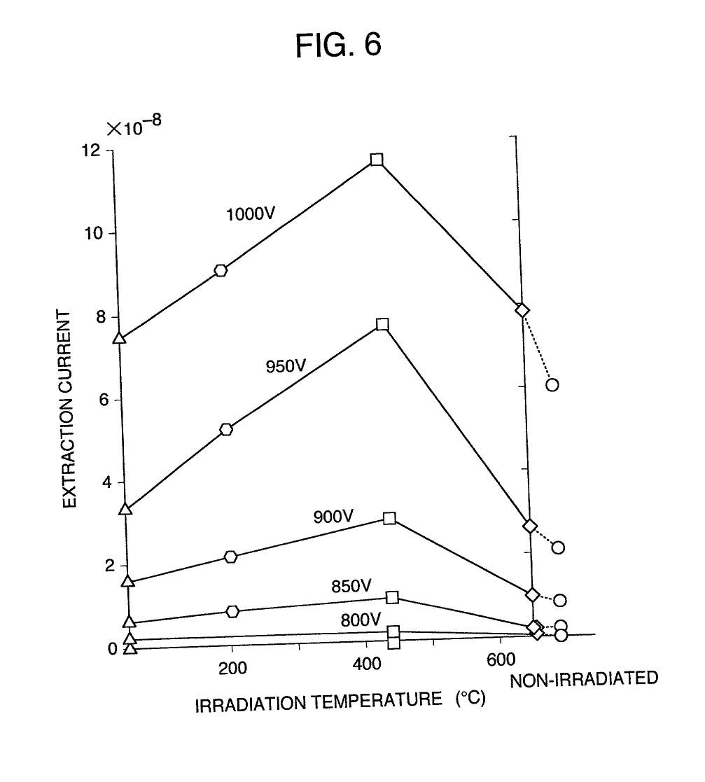

FIG. 5 shows the experimental results on extraction voltage and emission current characteristics of an electron emitter using the multilayer carbon nanotubes hydrogenated at various irradiation temperatures as shown in FIG. 3, comparing with characteristics of a carbon nanotube ignition-treated under vacuum without a hydrogenation to eliminate adsorbed materials. It shows comparisons of electron emission characteristics of electron emitters irradiated with hydrogen ions having an acceleration energy of 330 eV at room temperature, 440° C. and 650° C. It is found that the electron emitters irradiated with hydrogen ions have improved emission characteristics with a higher extraction current (emission current) in any case in comparison with the non-irradiated emitter. FIG. 6 also shows dependency of the emission current on the irradiation temperature at each extraction voltage based on the data in FIG. 5. The emission current shows a tendency that it increases with the increase in irradiation temperature of hydrogen ions from room temperature up to around 440° C., but decreases at about 440° C. up to 650° C. This tendency is similar to the tendency of the effect of the irradiation temperature on the ratio of the >CH— bonding group among various C—H bondings. From these results, it becomes clear that the fraction of the >CH— bonding group depends on the irradiation temperature and that the higher the fraction of >CH— bonding group, the more the emission characteristics is improved. As already described above, in the graph in FIG. 2 in which the electron emission current at the extraction voltage of 900 V is plotted against the relative ratio of >CH— bonding group obtained from the results in FIG. 4, it is found that there is a positive correlation between the fraction of the >CH— bonding group and the emission current. On the other hand, any correlation was not observed between the relative densities of ═CH— or —CH₃ bonding group and the emission current. Also it is found there is a negative correlation between the fraction of >CH₂ bonding in the region from room temperature to 450° C. and the emission current. Although any sample irradiated with hydrogen ions has more superior electron emission characteristics than the non-irradiated samples, there is a tendency that the lower the emission temperature the lower the emission characteristics in the range of 100-450° C. This is because the ratio of the >CH— bonding group to other CHₓ bonding groups, the former contributing to the reduction of surface work function, varies in proportion to the ratio of graphite-like structure, and thus the ratio is higher as the irradiation temperature becomes higher in this range of the emission temperature. Taking into consideration of these results, the irradiation temperature ranges preferably 100-650° C., more preferably 200-550° C.

As explained above, a high density emission current can be obtained at a low voltage by using a carbon nanotube having >CH— bonding groups in which a carbon atom is linked to three neighboring carbon atoms and a hydrogen atom is linked to the carbon atom on an electron emission surface as an electron emitter according to this example.

In addition, because the carbon nanotube having hydrogenated graphite layers is modified with hydrogen in defects such as tip parts which are intrinsically chemically reactive, it is chemically very stable and thus not oxidized even when left in air. Therefore, it can advantageously provide very stable characteristics for an electron emitter or applications to other purposes. It also has an advantage of an improved dispersion in non-polar solvents by the hydrogenation. Furthermore, it also has another advantage of a larger average distance among carbon nanotubes due to >CH₂ or >CH bonding groups saturated with hydrogen existing in defect parts at both ends or side surface, resulting in easier dispersion with little coagulation.

Next, another example of the electron emitter of the present invention will be explained.

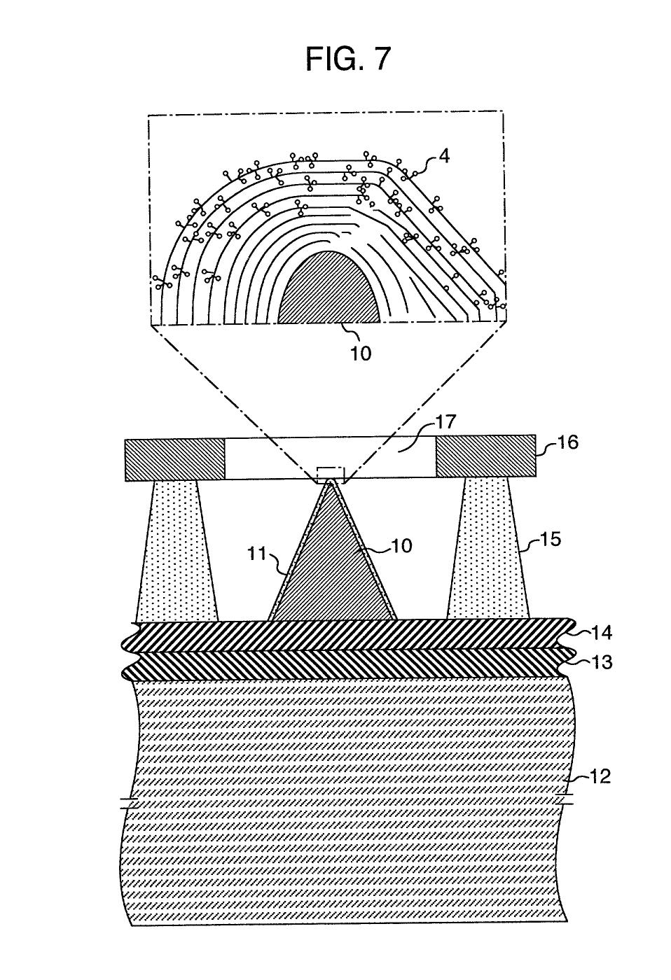

FIG. 7 is a schematic drawing showing a cross sectional structure of a set of an electron emitter, gate electrode insulation layer and gate electrode, which set is a basic unit in applying the electron source according to the present invention to FED, backlight for a liquid crystal display and light source for a projection type display. A resistance layer 14 is provided on a cathode 13 formed on a glass substrate 12, and a molybdenum gate electrode 16 having an opening 17 is formed on the resistance layer 14 by a lithography technique. Further, a circular cone or pyramidal core protrusions 10 made of molybdenum is formed coaxially with an opening of the gate electrode 14 by means of Spint method, on which the outermost surface layer 11 of the hydrogenated carbon-based electron emitter is provided. Rough dimensions of the circular cone core protrusions 10 is: 1 μm for diameter of the bottom, 1.3 μm for height, and the typical thickness of the electron emitter layer 11 is 100 nm. The method to form the electron emitter layer: a carbon film having a thickness of 1-10 nm was firstly formed on the surface of the circular cone core protrusions 10 by a sputtering method, followed by a hydrogen ion irradiation to the carbon film to produce the electron emitter layer. The temperature of the substrate 12 was kept at 450° C. during the irradiation of the hydrogen ions to attempt to optimize the film characteristics of hydrogenated graphite layer structure. A hydrogen plasma irradiation can be used instead of the hydrogen ion irradiation, but even in this case, the substrate temperature during irradiation must be also at least not lower than 100° C., preferably not lower than 200° C., because the substrate temperature during irradiation lower than 100° C. gives amorphous carbon layers including insufficient graphite structure component, that is, insufficient electric conductivity, resulting in failing to fully utilize the effects of the hydrogenation. In addition, the irradiation temperature not lower than 650° C. reduces a concentration of hydrogen retained in the carbon layer to the level of not higher than 4% in H/C ratio, and cannot provide the hydrogenation effects sufficiently. A magnified view of the cross sectional structure of the head part of the electron emitter hydrogenated under the above-mentioned conditions is shown in the inserted drawing enclosed with a dot chain line in FIG. 7. Atomic array and state of hydrogen bonding in a graphite crystallite just under an electron emission surface are schematically shown. Of the carbon atoms on the edge, a carbon atom linked to two neighboring carbon atoms forms a >CH₂ bonding group by linking to two hydrogen atoms 3, on the other hand, a carbon atom linking to three neighboring carbon atoms forms a >CH— bonding group by linking to one hydrogen atom 4, and thus they contribute to the increase of electron emission amount. As the cone core protrusions other than this, silicon, niobium, nickel, tungsten, rhenium, iron, chrome, platinum and copper or alloys of two or more elements thereof such as iron-nickel-chrome alloy, tungsten-rhenium alloy, nickel-chrome alloy and copper-nickel alloy can be used. Titanium carbide, titanium nitride and carbon as well as phenolic resins and polyimide resins can also be used.

An advantage of the electron emitter of this example is that it permits improving the heat resistance of emitters of conventional Spint type or those formed by a lithography, and accordingly dramatically reducing the probability of erosion of the emitters duet arcing. Another advantage is an effect to reduce threshold voltage for electron emission of conventional electron emitters and thus reduce the drive voltage, that is, gate voltage for an on-off control of electron beams.

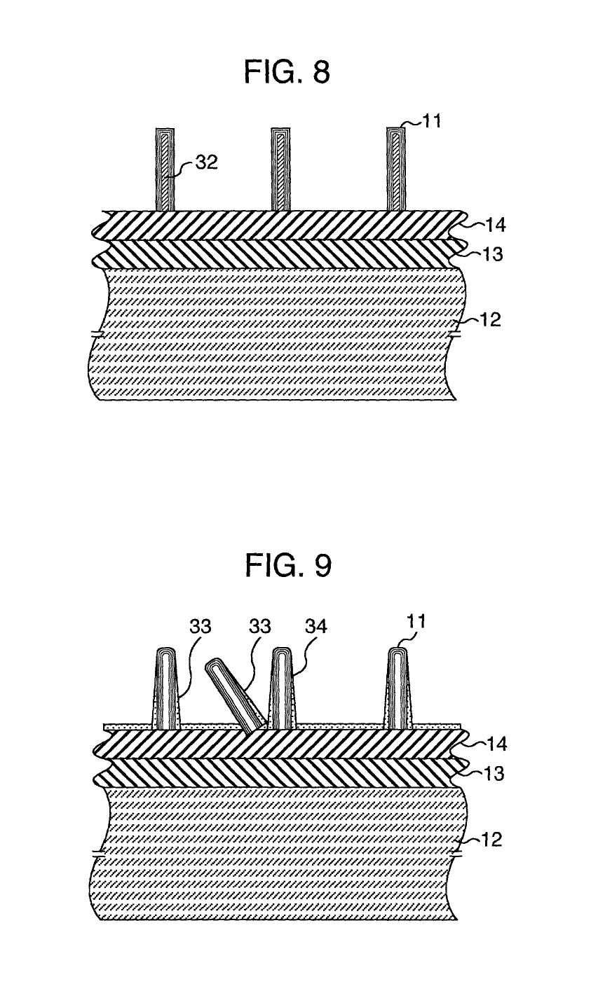

FIG. 8 is a conceptional drawing of an electron emitter showing another example of the present invention. A carbon-based electron emitter layer is formed so as to cover the surface of needle-like electroconductive core protrusions oriented vertically on an electric resistance layer formed via a cathode on a glass substrate. As the needle-like core protrusions, needle-like iron crystals with average diameter of 30 nm and length of 400 nm are used. A cathode 13 is formed by printing a paste of tungsten fine powder on a substrate 12, thereafter a carbon film 14 is formed thereon by sputtering. Needle-like iron core protrusions dispersed in an organic solvent is coated on the carbon film 14 under a DC magnetic field applied in vertical direction to the substrate, so that they are oriented and fixed vertically to the substrate. In the same state, an impurity layer is eliminated from the surface of the needle-like core protrusions using rare gas ions, while sharpening the tip shape, then a carbon sputter layer with an average thickness of 5 nm is formed by sputtering using a graphite target. By a series of these processes, the needle-like metal core protrusions were covered with carbon and fixed in such state as oriented nearly vertically on the electrode. Then hydrogen irradiation was carried out by exposing the resultant protrusions to a hydrogen ion beam with an acceleration energy of 100 eV or to a hydrogen plasma at a minus bias voltage applied to the substrate while keeping the substrate temperature at 450° C. As a needle-like metal core protrusions other than iron which can be oriented by a magnetic field, chrome, cobalt, nickel and alloys of two or more metals thereof such as iron-chrome-nickel can be used.

As an alternative method for forming an electrode with vertically standing, needle-like core protrusions, the following method can be used: A powder of an electroconductive needle-like core protrusions such as iron having a graphite coating layer formed on its external circumferential surface is dispersed in a binder to give a paste, then the paste is coated on an electrode part on a substrate in a magnetic field. As a method for forming hydrogenated graphite layer on an electron emission layer, a method of irradiating a substrate with hydrogen ion beam or hydrogen plasma while heating the substrate can be used. An advantage of the electron emitter prepared using the needle-like metal core protrusions compared with the emitters prepared by the conventional methods such as lithography method, molding method or Spint method is that the former enables to realize a larger area of electron emitter array at lower cost, since a printing method can be adopted.

FIG. 9 is a conceptional drawing of an electron emitter with an electroconductive coating layer 33 formed on at least a part of side surface of the layers other than electron emitter layer of a carbon nanotube with a hydrogenated graphite tip. A carbon electrode 14 is formed via an electroconductive electrode 13 on the surface of a glass substrate 12, on which a carbon nanotube 34 is fixed using a binder. Subsequently the metal coating layer 33 with average thickness of 5 nm is formed by a vapor deposition of copper or nickel or by sputtering with tungsten. Then the metal coating layer formed in the tip of the electron emitter is removed as well as hydrogenation treatment of graphite by sputtering using hydrogen ion irradiation or hydrogen plasma irradiation in a state under a bias voltage applied condition. In this process, because ion incident flux on a head part of the electron emitter is far higher than in a side surface, sputtering speed for the metal coating layer in the head part can be made faster than for the side surface, enabling selective removal of the metal coating layer in the head part. The electron emitter thus formed can provide a conductivity by the metal coating layer formed in an external circumferential part, even if a conductivity of the carbon nanotube is deteriorated by a bombardment of ionized residual gas going back through an acceleration electric field against the electron emitter in a medium degree of vacuum region. Accordingly, the presence of an electroconductive layer resistant to an ion bombardment retains the conductivity between the electron emitter layer as an electron emitter and the lower electrode 14, and thus makes it possible to suppress a deterioration of electron emission characteristics.

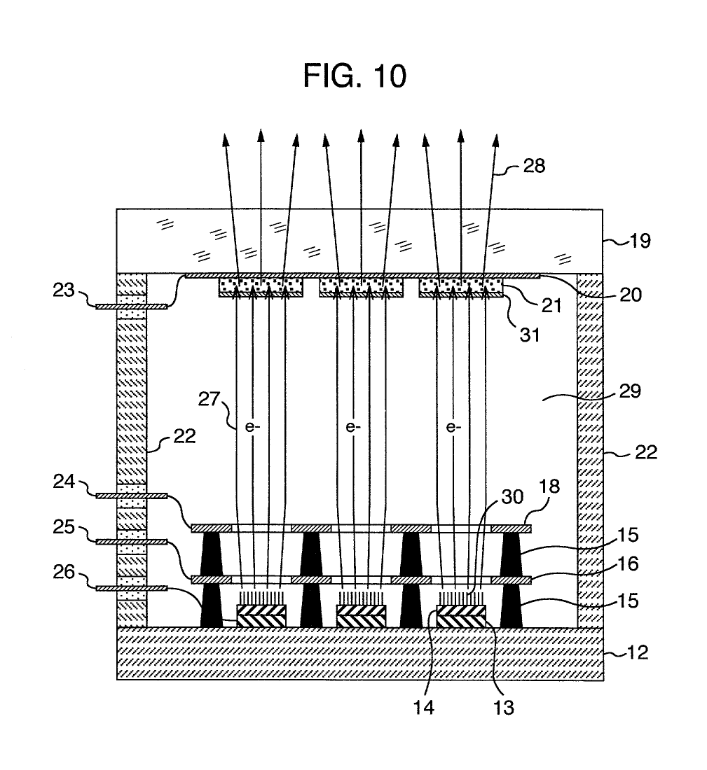

As another example, an electric emitter of the present invention was applied to an image display device. FIG. 10 is a conceptional drawing schematically showing a cross sectional structure cut perpendicularly to the scanning lines of a flat type display in which the electron emitters formed on needle-like core protrusions of the present invention are arranged like a two-dimensional array. Electron emitters 30 having a needle-like structure are arrayed in plane within a given area as cathode elements, which are arranged like a two-dimensional array. For each cathode element, a gate electrode 16 and focusing electrode 18 made of molybdenum vapor deposition film are provided between two-stage of insulation layer 15. A light transmitting glass window 19 is arranged in opposite to a substrate 12 by joining it to side walls 22 of a vacuum chamber made of glass. The whole vessel is air tightly sealed under an ultra high vacuum level. The major component of residual gas 29 in the vacuum chamber is hydrogen and adjusted at not less than 1×10⁻⁶ Pa and not higher than 5×10⁻⁵ Pa in order to compensate hydrogen physically released from the electron emitter layer by bombardment of counter flow ions from the acceleration electrode, as well as clean up the outermost surface of the electron emitter layer. The hydrogenation can lower the polarity of electron emitter surface and reduce the adsorption frequency of adsorbed polar molecules, and thus makes it possible to enhance the stability of an electron emission current. On the other hand, if the hydrogen partial pressure exceeds the above described range, wear of the electron emitter is accelerated by the incidence of hydrogen ions ionized by the irradiation of electron beam and raises a problem to shorten the lifetime of the emitter. An acceleration electrode 20 is installed on an inner surface of the vacuum side of the light transmitting glass window 19, and a phosphor layer 21 is formed on the acceleration electrode. An aluminum film 31 with a thickness of 2 μm is deposited on a surface of phosphor layer 21 to prevent the decomposition of the layer by a bombardment of electron beam, as well as to improve the utilization efficiency of the light excited in the phosphor layer by efficiently reflecting toward the direction of the light transmitting glass window. In the side wall 22 of the vacuum glass vessel or on the substrate 12, a current introduction terminal for acceleration electrode 23, a current introduction terminal for focusing electrode 24, a current introduction terminal for gate electrode 25 and a current introduction terminal for cathode 26 are mounted and each of them is connected electrically with the acceleration electrode 20, the focusing electrode 18, the gate electrode 16 and the cathode 13, respectively. The numbers of the gate electrode 16 and the cathode 13 mounted correspond to the number of pixels, and therefore the numbers of the current introduction terminal for gate electrode 25 and the current introduction terminal for cathode 26 mounted also correspond to the number of pixels. An electric field is generated at the tip of the electron emitter 30 by a high voltage from +6 kV to +10 kV applied to the acceleration electrode, and the field emission electron 27 is emitted toward the acceleration electrode 20, focused by the focusing electrode 18, transmitted through the aluminum layer 31 and enters into the phosphor layer 21. The gate electrode is used to intercept an electron beam by applying a negative gate voltage. When iron, cobalt or alloys thereof are used as the core protrusions 10 composing the electron emitter 30, a divergence angle of emitted electrons can be narrowed and an improvement of brightness in the major axis direction can be observed by forming the electron emitter with the core protrusions magnetized in its major axis direction in advance.

As described above, a high density emission current can be obtained at a low voltage by applying the hydrogenated electron emitter of the present invention to an electron emitters for the electron beam image display device. In addition, the electron emitter can also provide superior arc resistance and high reliability because the electron emitter surface is formed with carbon film or hydrogenated carbon film.

Although this example explains an embodiment using an electron emitter in which a hydrogenated carbon film is formed on a surface of needle-like core protrusions, the similar effects can also be obtained by using the hydrogenated carbon nanotube according to the other example of the present invention or the electron emitters with a hydrogenated carbon film formed on the surface of the core protrusions formed by Spint method or a lithography method.

The electron emitter according to the present invention can be applied to various electron beam application devices such as FED, backlight for liquid crystal display and flat type light source for projection type display, and provides more compact devices with higher energy efficiency and high performance. Furthermore, by applying the electron emitter of the present invention, the following can be obtained: a fluorescent character display tube superior in luminous efficiency, a compact electron source for X-ray tube with low power consumption, an electron emitter for surge absorber, an electron source for free electron laser, a compact power breaker for high voltage with high pressure resistance, a compact electron source for traveling wave tube superior in rapid start up and an electron tube for microwave generation.

The electron beam devices installing the electron emitter of the present invention enables to attain electron beam devices featuring in light weight, compact, power saving and low cost due to the elimination of a power source for heating cathode, which has been indispensable to the electron beam devices using a conventional thermionic type electron source, the simple structures and the rapid start up performance without preheating. In particular, in electric beam devices requiring rapid switching of an electron beam, any general purpose semiconductor circuit can be used as a power circuit system for switching of an electron beam, and thus it has become possible to save costs in making a drive circuit system. Until now, many attempts have been made to field emission type electron sources using a metal electron emitter made of molybdenum, nickel or the like, but they still have problems of an erosion on the tip end by arc, high gate voltage due to large radius of the tip end, high manufacturing costs for a drive circuit system and a poor long term stability. The electron source according to the present invention can solve all these problems. Moreover, it can also be effective in preventing the deterioration in electron emission current characteristics, which deterioration has caused a problem in using a carbon-based electron emitter, in particular, a carbon nanotube under a medium degree of vacuum region, and thus provide a practical electron source with a superior long term reliability.

As explained above, the present invention can provide a high emission current at a low extraction voltage and attain an electron emitter with little deterioration in emission characteristics under a medium degree of vacuum level.

What is claimed is:

1. A carbon nanotube characterized by comprising a >CH— bonding group in which a carbon atom is linked to three neighboring carbon atoms and one hydrogen atom is linked to said carbon atom.

2. An electron emitter characterized by comprising a >CH— bonding group in which a carbon atom is linked to three neighboring carbon atoms and one hydrogen atom is linked to said carbon atom.

3. An electron emitter characterized by comprising a >CD— bonding group in which a carbon atom is linked to three neighboring carbon atoms and a deuterium atom is linked to said carbon atom.

4. An electron emitter characterized by having, within a C—H bonding stretching vibrational infra-red absorption spectrum region, a peak component whose center of gravity is located at 2892±4 cm⁻¹ corresponding to stretching vibration of >CH—.

5. An electron emitter characterized in that a fraction of >CH— bonding group relative to C—H bonding groups in ═CH— bonding, —CH₃ bonding, >CH₂ bonding and >CH— bonding is at least 10%.

6. An electron emitter using a multilayer carbon nanotube, characterized in that graphite crystallites of said multiplayer carbon nanotube have an inter-layer spacing d₀₀₂ of 0.37 to 0.43 nm.

7. The electron emitter according to any one of claims 1-4, wherein said electron emitter is a carbon nanotube.

8. An electron emitter in which a film having carbon atom is formed on a surface of electroconductive core protrusions, wherein said carbon atom is a carbon atom linked to three neighboring carbon atoms, and composes >CH— bonding group in which one hydrogen atom is linked to said carbon atom linked to three neighboring carbon atoms.

9. An electron emitter characterized in that a metal layer is formed on at least a part of side surface of a carbon nanotube.

10. The electron emitter according to claim 9, wherein an electron emission surface of said carbon nanotube comprises >CH— bonding group in which a carbon atom is linked to three neighboring carbon atoms and one hydrogen atom is linked to said carbon atom.

11. A method for manufacturing an electron emitter characterized by comprising the step of forming hydrogenated carbon film having >CH— bonding group on an electron emission surface of an electron emitter by irradiating a carbon-based or hydrocarbon-based material with hydrogen plasma or hydrogen ion at a temperature of 100° C.-650° C.

12. The method for manufacturing an electron emitter according to claim 11, wherein said temperature ranges 300° C.-550° C.

13. An electron beam device having a vacuum chamber comprising the electron emitter according to any one of claims 2-10, an electron extraction electrode and current introduction terminals for providing a voltage to said electron emitter and said electron extraction electrode.

14. The electron beam device according to claim 13, wherein said vacuum chamber contains hydrogen in a pressure ranging from 1×10⁻⁶ Pa inclusive to 5×10⁻⁵ Pa inclusive.
